(19) United States
(12) Patent Application Publication
(10) Pub. No.: US 2022/0368165 A1
(43) Pub. Date: Nov. 17, 2022

(54) WIRELESS CHARGING DEVICE

(71) Applicant: Ningbo Weie Electronics Technology Ltd., Ningbo (CN)

(72) Inventors: Cong Yin, Ningbo (CN); Tao Ma, Ningbo (CN); Feng Yu, Ningbo (CN); Weiyi Feng, Ningbo (CN)

(73) Assignee: Ningbo Weie Electronics Technology Ltd., Ningbo (CN)

(21) Appl. No.: 17/727,282

(22) Filed: Apr. 22, 2022

(30) Foreign Application Priority Data
May 13, 2021 (CN) 202121026885.4

(51) Int. Cl. H02J 50/20; H02J 50/80; H02J 7/00; H02J 50/00

(52) U.S. Cl. CPC H02J 50/20; H02J 50/80; H02J 7/00047; H02J 50/005

(57) ABSTRACT

Disclosed in embodiments of the present disclosure is a wireless charging device, by setting a excitation source configured to input current of different frequencies to a transmitting circuit, implementing charge for electronic devices at different working frequencies wirelessly only through a set of transmitting circuit, there is no need of multiple sets of switchable transmitting circuit, so as to simplify the circuit structure and device structure, and reduce the manufacturing cost and improve the using convenience.

### CLAIM OF PRIORITY AND CROSS-REFERENCE TO RELATED APPLICATION(S)

This application claims the benefit of Chinese Patent Application No. 20212126885.4, filed on May 13, 2021, entitled “wireless charging device”, which is incorporated herein by reference in its entirety.

### BACKGROUND OF THE INVENTION

### 1. Field of the Invention

The present invention relates to the field of electronic device, and particularly to a wireless charging device.

### 2. Description of the Related Art

With the development of technology, more and more electronic products begin to offer wireless charging function, but the working frequency of wireless charging circuit of different products are variety. For example, the working frequency of wireless charging of common smart phones is generally in 100 kHz-250 kHz, while some electronic products, such as smart watches of certain brand series, have a working frequency of wireless charging in 280 kHz-350 kHz. In the present market, the solution of a product can charge the receiving products working in the above two operating frequencies is to switch the corresponding transmitting circuit in hardware and in the meanwhile switch the frequency in software, so as to provide wireless charging not only to the electronic products working in the frequency band of 100 kHz-250 kHz, such as smart phones, but also to the electronic products working in the frequency band of 280 kHz-350 kHz, such as smart watches of certain brand series. However, at least two transmitting coils need to be set in this way, which complicate the structure of charging device.

### BRIEF DESCRIPTION OF THE INVENTION

In view of the existing status, embodiments of the present disclosure provide a wireless charging device with a simpler structure that can charge different types of electronic products.

The embodiments of the present disclosure provide a wireless charging device, comprising:

a transmitting circuit, having only one transmitting coil; and

an excitation source, connecting in series with the transmitting circuit, the excitation source is used to input current at different frequencies to the transmitting circuit according to detected load type.

In some embodiments, the transmitting circuit further comprising:

a capacitor, connecting in series with the transmitting coil.

In some embodiments, the excitation source is configured to switch between first frequency band and second frequency band.

In some embodiments, the first frequency band is in 100 kHz-250 kHz and the second frequency band is in 280 kHz-350 kHz.

In some embodiments, resonant frequency of the transmitting circuit is in the first frequency band.

In some embodiments, the device further comprising:

a housing, the emitting circuit and the excitation source are installed inside the housing.

In some embodiments, a charging area is arranged on the housing, and the charging area is arranged at a position corresponding to the transmitting coil.

In some embodiments, the device further comprising:

a signal transmitter, configured to transmit signals to area to be charged;

a signal receiver, connecting with the excitation source for receiving signals returned by devices to be charged and transmitting the signals to the excitation source.

In some embodiments, frequency of the signals transmitted by the signal transmitter is in 100 kHz-250 kHz or 280 kHz-350 kHz.

In some embodiments, the device further includes:

a power detecting component, connecting with the transmitting circuit and the excitation source, the power detecting component configured to detect output power of the transmitting circuit and feed the output power back to the excitation source.

Disclosed in embodiments of the present disclosure is a wireless charging device, by setting a excitation source configured to input current of different frequencies to a transmitting circuit, implementing charge for electronic devices at different working frequencies wirelessly only through a set of transmitting circuit, there is no need of multiple sets of switchable transmitting circuit, so as to simplify the circuit structure and device structure, and reduce the manufacturing cost and improve the using convenience.

### BRIEF DESCRIPTION OF THE DRAWINGS

Through the following description of the embodiments of the present disclosure with reference to the drawings, the above and other objectives, features and advantages of the present disclosure will become more apparent, wherein:

FIG. 1 is a schematic diagram of circuit structure of related technologies;

FIG. 2 is a schematic diagram of a circuit structure for electric energy receiving of the wireless charging device and the devices to be charged according to the embodiments of the present disclosure;

FIG. 3 is a schematic diagram of the overall structure according to the embodiments of the present disclosure;

FIG. 4 is a schematic diagram of another circuit structure for electric energy receiving of the wireless charging device and the devices to be charged according to the embodiments of the present disclosure;

FIG. 5 is a schematic diagram of frequency switching principle according to the embodiments of the present disclosure;

FIG. 6 is a structural diagram of a excitation source according to the embodiments of the present disclosure;

FIG. 7 is a structural diagram of another excitation source according to the embodiments of the present disclosure;

### DESCRIPTION OF REFERENCE SIGNS

1, excitation source; 2, transmitting circuit; 3, power detecting component; 4, the housing; 41, charging area; 5, signal transmitter; 6, signal receiver; C, capacitor; L, transmitting coil; F1, first frequency band; F2, second frequency band.

### DETAILED DESCRIPTION OF EMBODIMENTS OF THE INVENTION

The present disclosure is described below on the basis of the embodiments, but is not merely limited to these embodiments. Specific details are described in detail in the following detailed description of the present disclosure. The present disclosure can also be fully understood by a person skilled in the art without the description of the details. In order to avoid confusing the essence of the present disclosure, commonly known method, process, flow, element and circuit are not described in detail.

In addition, a person skilled in the art should understand that the drawings herein are provided for the purpose of description only, and are not necessarily drawn in proportion.

It should also be understood that, in the following description, “circuit” means a conductive circuit consisting of at least one component or sub-circuit through an electrical or electromagnetic connection. When a component or circuit is said to be “connected” to another component or to be “connected” between two nodes, it may be directly coupled or connected to another component or there may be intermediate components, the connection between components may be physical, logical, or a combination thereof. Conversely, when a component is said to be “directly coupled” or “directly connected” to another component, it means that there is no intermediate component there between.

Unless otherwise stated, the terms “comprise”, “include” and the like in the entire application document shall be interpreted as inclusive rather than exclusive or exhaustive; in other words, the terms mean “include but not limited to”.

In the descriptions of the present disclosure, it should be understood that the terms like “first”, “second” and the like are used for the purpose of description only, but cannot be considered to indicate or imply relative importance. In addition, in the descriptions of the present disclosure, unless otherwise stated, the meaning of “a plurality of” is two or more.

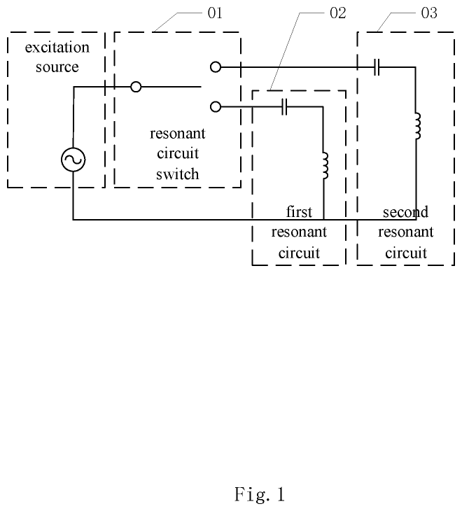

FIG. 1 is a schematic diagram of circuit structure of related technologies. As shown in FIG. 1, in the related technology, the transmitting circuit includes: resonant circuit switch 01, the first resonant circuit 02 and the second resonant circuit 03, and each resonant circuit includes a transmitting coil. Two groups of resonant circuit can be switched through the resonance circuit switch, so that the transmission circuit can use the transmitter coils in the different resonant circuits to launch different frequency power, so as to charge different device, this method apparently increased the complexity of the circuit and the complexity of the charger structure, leading to high production cost and inconvenience use.

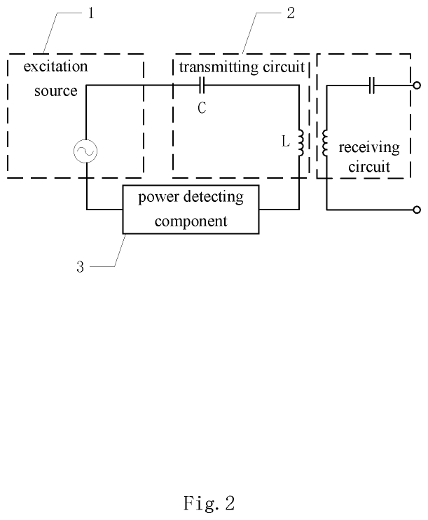

FIG. 2 is a schematic diagram of a circuit structure for electric energy receiving of the wireless charging device and the devices to be charged according to the embodiments of the present disclosure. As shown in FIG. 2, the wireless charging device in this embodiment includes a transmitting circuit 2 and an excitation source 1. Among them, the transmitting circuit 2 has only one transmitting coil L which can transmit electric energy to the external in a wireless way; the excitation source 1 is connected in series with the transmitting circuit 2 and is used to input current at different frequencies to the transmitting circuit 2 according to the detected load type. In this embodiment, excitation source 1 is half-bridge inversion circuit or full-bridge inversion circuit with a control chip, or AC excitation source of other forms, the excitation frequency is determined by the frequency of the control signal sent by the control pole. There has preset control program in the control chip, so as to regulate the control pole to transmit control signal in certain rules, and when different load types are detected, the control chip causes the control pole to transmit control signal at different frequencies, the excitation source 1 to transmit excitation current at different frequencies, so that the transmitter coil L of transmission circuit 2 can transmit electrical energy outwards at different frequencies. Specifically, excitation source 1 is configured to switch between the first frequency band and the second frequency band. For example, when a mobile phone is detected as the load, the excitation source 1 transmits an excitation current in the first frequency band, causing the transmitting coil L to transmit electrical energy in the first frequency band, so as to charge the mobile phone. When a watch is detected as the load, the excitation source 1 transmits an excitation current in the second frequency band, causing the transmitting coil L to transmit electrical energy in the second frequency band, so as to charge the watch. By setting excitation source 1, which can input excitation current at different frequencies to the transmitting circuit 2, implementing charge for electronic devices at different working frequencies wirelessly only through one transmitting coil L, there is no need of multiple switchable transmitting coil L, so as to simplify the circuit structure and reduce the manufacturing cost. And due to the simplified of the circuit structure, the device structure is simplified also, thereby being convenient to use.

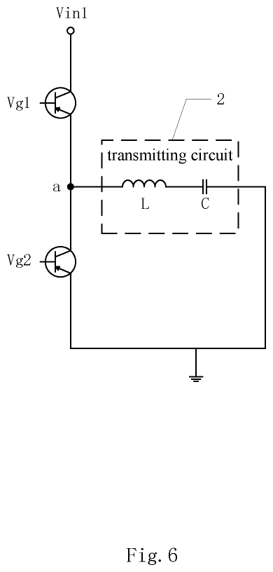

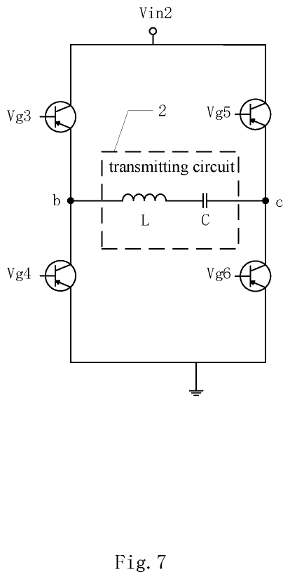

In an embodiment, the specific structure of excitation source 1 is shown in FIG. 6. Excitation source 1 is a half-bridge inversion circuit, in which, Vin1 is the DC input and Vg1 and Vg2 are voltage controlling inputs, DC is converted into AC in the inversion circuit, which then output at the midpoint A of the bridge arm, so as to drive the transmitting circuit 2 to transmit electric energy. Wherein, the frequency of AC, that is, the excitation frequency of the excitation source 1, is controlled by the frequencies of Vg1 and Vg2. In another embodiment, the specific structure of the excitation source 1 is shown in FIG. 7, the excitation source 1 is a full-bridge inversion circuit, in which Vin2 is the DC input and Vg3, Vg4, Vg5 and Vg6 are voltage controlling inputs. Similar to the above embodiment, the DC current is converted into AC in the inversion circuit and then output at the midpoints B and C of the bridge arms, so as to drive the transmitting circuit 2 to transmit electrical energy. Wherein, the frequency of AC, that is, the excitation frequency of excitation source 1, is controlled by the frequencies of Vg3, Vg4, Vg5, and Vg6.

In some optional implementation, the first frequency band is in 100 kHz-250 kHz, which is suitable for charging most common smart phone products that support the wireless charging function; the second frequency band is in 280 kHz-350 kHz, which is suitable for charging some smartwatches or other electronic devices that support wireless charging function.

In one specific embodiment, the transmitting circuit 2 also includes a capacitor C. The capacitor C is connected in series with the transmitting coil L. At this point, the transmitting circuit 2 is the LC resonant circuit composed of the transmitting coil L and the capacitor C. After being excited by the excitation source 1, the LC resonant circuit will transmit electrical energy from the transmitting coil outwards in a wireless way.

In one specific embodiment, the resonant frequency of the transmitting circuit 2 is in the first frequency band. When the excitation current frequency of the excitation source 1 is also in the first frequency band, the excitation current frequency matches the resonant frequency of the transmitting circuit 2. At the time, the transmitting circuit 2 has a high power and can quickly charge the electronic devices (such as smart phones) working in the first frequency band. When the excitation current frequency of the excitation source 1 is in the second frequency band, the excitation current frequency does not match the resonant frequency of the transmitting circuit 2. At the time, the transmitting circuit 2 has a low power, accordingly, the charging speed of the electronic devices (such as smart watches) working in the second frequency band is slow. Therefore, in the implementation process, the working frequency band of wireless charging for electronic devices such as mobile phones with high power consumption should be set in the first frequency band, and the resonant frequency of transmitting circuit 2 should be matched with it, so as to improve the charging efficiency. And working frequency band of wireless charging for smart watches and other small electronic devices that have relatively low power consumption can be set in the second frequency band, so even though the charging speed is slow because the resonance frequency of the transmitting circuit 2 and the excitation current of excitation source 1 doesn't match to each other, due to the devices to be charged have less power consumption and smaller power storage, the need of charging can still be satisfied.

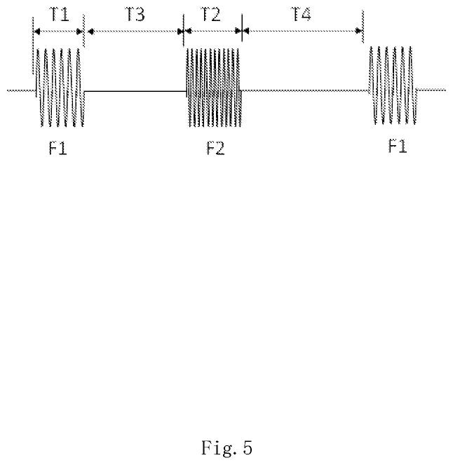

In an optional embodiment, the wireless charging device of this embodiment also includes a power detecting component 3. The power detection module 3 is connected to the transmitting circuit 2 and the excitation source 1, being configured to detect the output power of the transmitting circuit 2 and feed it back to the excitation source 1. When the device is standing by, the excitation source 1 drives the transmitting circuit 2 to transmit electric energy at different frequencies according to certain rules. When the device to be charged is in the area to be charged, the device to be charged will receive the electric energy in its matching charging frequency. At the time, as the load is accessed, the power of the transmitting circuit 2 will increase. At the same time, the receiving circuit of the load will perform the handshake protocol when it receives the electric energy signal matching its charging frequency, so that the received power will change according to certain regularity, and the transmitting power of the transmitting circuit 2 will also change accordingly. At the time, the power detection module 3 connected to the transmitting circuit 2 will detect the change of the power and feed it back to the excitation source 1, so that the excitation current frequency of the excitation source 1 remains at the present frequency. Thus, the continuous charging for the charging devices can be implemented. Specific, the regularity of the excitation source 1 driving the transmission circuit 2 to transmit electronical energy at different frequencies is showed in FIG. 5, first, the excitation source 1 drives the transmission circuit 2 to transmit signals in the first frequency band F1 for an interval time T1, if there has device to be charged, which has a receiving frequency in the first frequency band, in the area to be charged, perform the handshake protocol and start to charge at F1 frequency as described above, after the power detector module 3 detects the change of the power. When the power detecting component 3 doesn't detect the power change within time T1, the excitation source 1 will stop exciting, and after an interval time T3, starting to excite the transmitting circuit 2 in the second frequency band F2 for an interval time T2. If there has device to be charged, which has a receiving frequency in the second frequency band, in the area to be charged within time T2, perform the handshake protocol, and then the power detector module 3 feeds the detected power change back to the excitation source 1, causing the excitation source 1 and the transmitting circuit 2 to work in the second frequency band, so as to charge the device has a receiving frequency in the second frequency band. If the power detecting component 3 hasn't detected the power change within time T2, the excitation source 1 will stop exciting, and repeat the above operation after an interval time T4, transmitting signals in the order of T1-T3-T2-T4, until the device to be charged is detected.

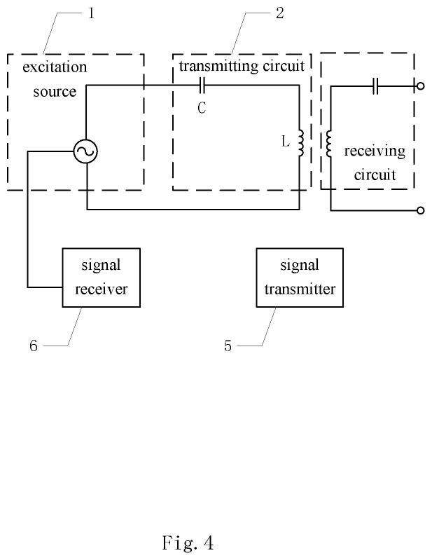

FIG. 4 is a schematic diagram of another circuit structure for electric energy receiving of the wireless charging device and the devices to be charged according to the embodiments of the present disclosure. As shown in FIG. 4, in another optional implementation, the wireless charging device also includes the signal transmitter 5 and the signal receiver 6. The signal transmitter 5 is configured to send signals to the area to be charged, signal receiver 6 is connected with the excitation source 1 to receive the signals returned by the devices to be charged and feed it back to the excitation source 1. In this implementation, the signal transmitter 5 is independent equipment that sends wireless signals to the area to be charged by means such as Bluetooth and NFC. When there is a device to be charged in the area to be charged, the device to be charged will execute the handshake protocol and feedback a signal after receiving the signal sent by signal transmitter 5. After receiving the feedback signal, signal receiver 6 sends it to excitation source 1, which determines the frequency of the excitation current according to the types of feedback signal. Specifically, as shown in FIG. 5, first, the signal transmitter 5 will transmit a signal, which has a frequency in the first frequency band, for an interval time T1, if there has device to be charged, which has a receiving frequency in the first frequency band, in the area to be charged, then the device to be charged will feed a feedback signal back to the signal receiver 6, the signal receiver 6 will transmit the feedback signal to the excitation source 1 after receiving, and the excitation source 1 will transmit an excitation current, which has a receiving frequency in the first frequency band, to the transmitting circuit 2 after receiving the feedback signal, causing the transmitting circuit 2 to transmit electronical energy in the first frequency band, so as to charge the device to be charged. If the signal receiver 6 doesn't receive the feedback signal within time T1, the signal transmitter 5 will stop transmitting the signal in the first frequency band for an interval time T3, and start to transmit the signal in the second frequency band for an interval time T2. If the signal receiver 6 receives the feedback signal within time T2, the excitation source 1 and the the transmitting circuit 2 will work in the second frequency band, so as to charge the device has a receiving frequency in the second frequency band. If the signal receiver 6 hasn't detected the power change within time T2, the signal transmitter 5 will stop transmitting signals, and repeat the above operation after an interval time T4, transmitting signals in the order of T1-T3-T2-T4, until the device to be charged is detected. In this implementation, the frequency of the signal transmitted by the signal transmitter 5 are in: the first frequency band 100 kHz-250 kHz and the second frequency band 280 kHz-350 kHz. It should be emphasized that the frequency band of the embodiment is only used as an example and is not specifically limited. People skilled in the art can choose the frequency band freely according to their needs.

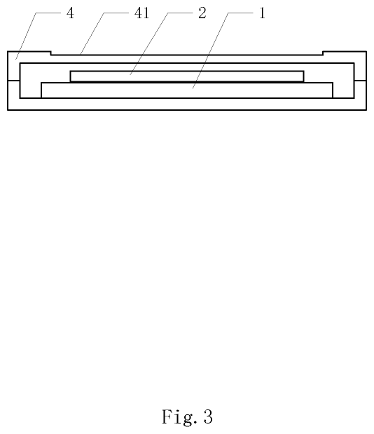

As shown in FIG. 3, in a specific embodiment, the wireless charging device also includes housing 4. The transmitting circuit 2 and the excitation source 1 are installed inside the housing 4. Due to the simplified circuit structure, the structure of housing 4 is relatively simple, which further reduces the manufacturing cost, reduces the volume of the wireless charging device, and reduces the space it occupies.

Specifically, housing 4 is provided with a charging area 41, and charging area 41 is arranged at the position corresponding to the transmitting coil L. Due to the simplified circuit structure, the wireless charging device has only one set of transmitting circuit 2, has only one transmitting coil L, so that only one charging area 41 can be arranged on housing 4, and there is no need to set charging areas for the two frequency bands respectively. Thus, the structure of the device is simplified and convenient to use.

The descriptions above are only preferred embodiments of the present disclosure, but are not intended to limit the present disclosure. For a person skilled in the art, the present disclosure may have various changes and variations. Any modifications, equivalent substitutions, improvements and the like made within the spirit and principles of the present disclosure are all intended to be concluded in the protection scope of the present disclosure.

I/We claim:

1. A wireless charging device, comprising:
a transmitting circuit (2), having only one transmitting coil (L); and
an excitation source (1), connecting in series with the transmitting circuit (2), the excitation source (1) is used to input current at different frequencies to the transmitting circuit (2) according to detected load type.

2. The wireless charging device according to claim 1, wherein the transmitting circuit (2) further comprising:
a capacitor (C), connecting in series with the transmitting coil (L).

3. The wireless charging device according to claim 1, wherein the excitation source (1) is configured to switch between first frequency band and second frequency band.

4. The wireless charging device according to claim 3, wherein the first frequency band is in 100 kHz-250 kHz and the second frequency band is in 280 kHz-350 kHz.

5. The wireless charging device according to claim 3, wherein resonant frequency of the transmitting circuit (2) is in the first frequency band.

6. The wireless charging device according to claim 1, wherein the device further comprising:
a housing (4), the emitting circuit (2) and the excitation source (1) are installed inside the housing (4).

7. The wireless charging device according to claim 6, wherein a charging area (41) is arranged on the housing (4), and the charging area (41) is arranged at a position corresponding to the transmitting coil (L).

8. The wireless charging device according to claim 3, wherein the device further comprising:
a signal transmitter (5), configured to transmit signals to area to be charged;
a signal receiver (6), connecting with the excitation source (1) for receiving signals returned by devices to be charged and transmitting the signals to the excitation source (1).

9. The wireless charging device according to claim 8, wherein the signal receiver (6) is configured to receive feedback signals from the devices to be charged in the area to be charged, and transmit the feedback signals to the excitation source (1).

10. The wireless charging device according to claim 9, wherein the excitation source (1) is configured to transmit an excitation current in the first frequency to the transmitting circuit (2) and cause the transmitting circuit (2) to transmit electronical energy in the first frequency band, in response to the feedback signals; or
the excitation source (1) is configured to transmit an excitation current in the second frequency to the transmitting circuit (2) and cause the transmitting circuit (2) to transmit electronical energy in the second frequency band, in response to the feedback signals.

11. The wireless charging device according to claim 8, wherein frequency of the signals transmitted by the signal transmitter (5) is in 100 kHz-250 kHz or 280 kHz-350 kHz.

12. The wireless charging device according to claim 3, wherein the device further includes:
a power detecting component (3), connecting with the transmitting circuit (2) and the excitation source (1), the power detecting component (3) configured to detect output power of the transmitting circuit (2) and feed the output power back to the excitation source (1).

13. The wireless charging device according to claim 12, wherein the excitation source (1) is configured to transmit excitation current in the first frequency band in response to the power detecting component (3) detects changing of the output power; or
transmit the excitation current in the first frequency band for first interval time, in response to the power detecting component (3) doesn't detect changing of the output power within the first interval time, stop transmitting the excitation current in the first frequency band, and after third interval time, transmit excitation current in the second frequency band; or
transmit the excitation current in the first frequency band for the first interval time, in response to the power detecting component (3) doesn't detect changing of the output power within the first interval time, stop transmitting the excitation current in the first frequency band, after the third interval time, transmitting the excitation current in the second frequency band for second interval time, and in response to the power detecting component (3) doesn't detect changing of the output power within the second interval time, stop transmitting the excitation current in the second frequency band.

14. The wireless charging device according to claim 13, wherein the transmitting circuit (2) is configured to transmit electromagnetic field in the first frequency band in response to the excitation current in the first frequency band from the excitation source (1);
transmit electromagnetic field in the second frequency band in response to the excitation current in the second frequency band from the excitation source (1).

15. The wireless charging device according to claim 8, wherein the signal transmitter (5) is one of a Bluetooth transmitter and a NFC transmitter.
